(19) United States
(12) Patent Application Publication
(10) Pub. No.: US 2003/0222922 A1
(43) Pub. Date: Dec. 4, 2003

(54) Automatic layout generation

(76) Inventor: Bernard Rummel, Schriesheim (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/232,942

(22) Filed: Aug. 30, 2002

Related U.S. Application Data
(60) Provisional application No. 60/386,106, filed on Jun. 4, 2002.

(51) Int. Cl. G09G 5/00

(52) U.S. Cl. 345/789; 345/801

(57) ABSTRACT

Automatic layout generation where elements and group boxes may be placed in layout styles. Elements have widths that are integer multiples of a standard width. The standard width and a width of a layout shape are used in selecting a layout style. If at least two group boxes are not wider than half the layout shape width, a layout style is selected that provides spacing between side-by-side group boxes and that may accommodate group boxes wider than the predetermined width. If one, or no, such group box is present, a layout style may be selected that does not provide such spacing.

CROSS-REFERENCE TO RELATED APPLICATIONS

This application claims benefit from U.S. Provisional Application No. 60/386,106, filed Jun. 4, 2002 and entitled “Methods and Apparatus for Automatic Form Generation,” which is incorporated by reference in its entirety.

### TECHNICAL FIELD

The invention relates to generating layouts for display on computer screens or other display terminals.

### BACKGROUND

Many computer applications use visual user interfaces. A graphical user interface includes one or more graphic elements in a layout for display on a computer screen. The graphic elements are associated with the function(s) of the computer application and may include buttons, text entry fields, labels, checkboxes, drop-down menus, etc. The graphical elements in the layout provide data input from, and data output to, the user, for example by the user clicking on a button, entering data in a field or reading text in a message box.

The order of the graphical elements in the layout may be important for several reasons. First, a certain layout design may affect users' ability to learn and operate the program. Second, inefficient use of screen area (sometimes referred to as “real estate” in this context) may force a user to scroll the screen to see the entire layout. Alternatively, inefficient use of real estate may cause an unnecessary number of layouts to be included in the application. This, in turn, may increase storage demands and slow down operation.

Layouts are typically generated by a manual process. The graphical elements that should be provided in the user interface are often identified during the development of the application. The developer may then generate the layout by placing the graphical elements in order on an empty sheet. When the layout is finished, it is stored together with the computer application so that it can be displayed during operation.

Creating layouts manually may have disadvantages. For example, efficiency and quality may be affected by factors such as the cost of the employee, the time required to finish the work, and the risk for mistakes. If several people create layouts for a project, it may also be difficult to maintain a consistent appearance between the different layouts.

Attempts have been made to automate the generation of forms for computer applications. One such attempt is an application that takes an existing table of elements and generates a form by automatically placing the elements from the table one after the other in a column. This solution may lead to an inefficient use of real estate because it does not take the elements' sizes into account when placing them in the layout.

Another automation attempt focuses on customizing existing layouts by removing elements. The user decides which elements should no longer be included in the layout and causes the user interface to delete them. The user interface may then compress the layout from the bottom towards the top to preserve some of the real estate occupied by these elements. This solution may not provide an initial layout and the compression may disturb the relation between elements.

Layouts may also present issues when it comes to customizing a finished system. Many computer systems are sold with pre-generated user interfaces where the customer (user) cannot modify forms that are displayed on the screen. Moreover, systems that allow modification of forms may not support the customization process sufficiently that the user can create functional and esthetically acceptable layouts.

### SUMMARY

The invention relates to automatic generation of layouts. In one general aspect, the invention provides a method of generating a layout for a computer user interface. A plurality of elements to be placed in a layout is received. Each element has a width that is an integer multiple of a standard width. A width of a layout shape in which the plurality of elements are to be placed is also received. The layout shape is provided with a layout style, which is selected using the layout shape width and the standard width. The layout is automatically generated by placing the plurality of elements in the selected layout style.

Elements may be placed in group boxes. If there are at least two group boxes in the plurality of elements that are not wider than half the layout shape width, a layout style may be selected that provides a spacing between side-by-side group boxes. If there is at most one group box that is not wider than half the layout shape width, a second layout style may be selected that does not providing said spacing.

In some implementations of the invention, at least one element may be automatically rearranged. The rearrangement may increase the efficiency in real estate use and make the layout easier to use. Rearrangement of group boxes may be rearranged to serve similar purposes.

Some embodiments may improve consistency in creating multiple layouts by eliminating the layout differences sometimes introduced by manual layout generation.

Embodiments of the invention may be used in connection with modifying user interfaces of computer systems. Such embodiments may allow an owner of a computer system to automatically generate layouts when customizing an existing user interface.

### BRIEF DESCRIPTION OF DRAWINGS

FIG. 1 is a block diagram of a computer system including a layout generating module;

FIGS. 2A-2D are examples of layout shapes;

FIGS. 3A-3C are examples of layout styles in which elements can be placed;

FIG. 4A is an example of group boxes placed in the layout style of FIG. 3B;

FIG. 4B is an example of elements placed in the layout style of FIG. 3C;

FIG. 5 is an example of a layout style providing a spacing between side-by-side group boxes;

FIG. 6 is an example of group boxes placed in the layout style of FIG. 5;

FIG. 7A is a flow chart of steps that may be carried out by the system in FIG. 1;

FIG. 7B is another flow chart of steps that may be carried out by the system in FIG. 1;

FIGS. 8A-8C is an example of arranging group boxes in a layout; and

FIGS. 9A-9C is another example of arranging group boxes in a layout.

Like reference symbols in the various drawings indicate like elements.

### DETAILED DESCRIPTION

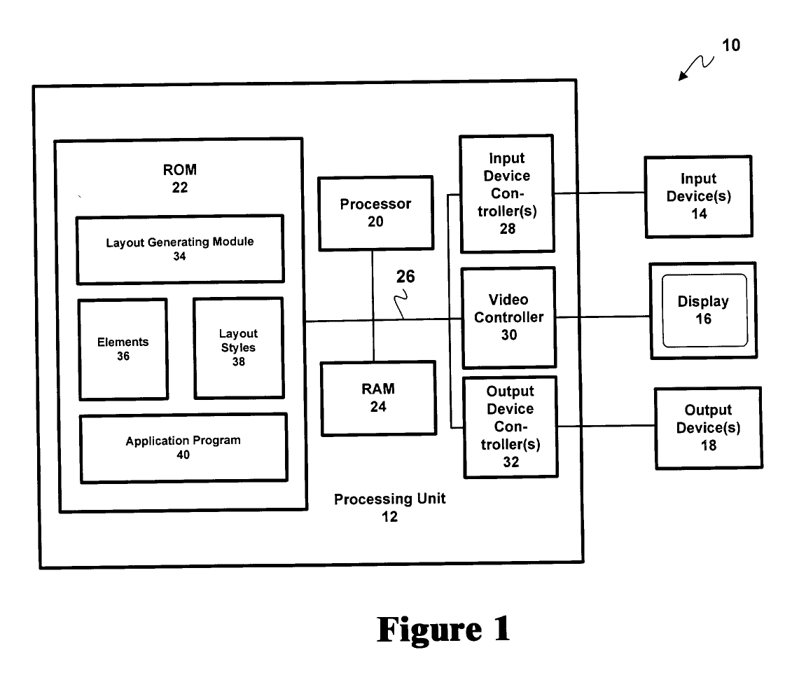

FIG. 1 shows a computer system 10 for generating layouts in accordance with the invention. The system 10 includes a processing unit 12 connected to input devices(s) 14 where the system 10 may receive elements that are to be placed in a layout according to the invention. Generated layouts may be shown on display 16. Output device(s) 18 may be used to output generated layouts.

The processing unit 12 includes a processor 20, read-only memory (ROM) 22, and random access memory (RAM) 24, all interconnected through data bus 26. Input device controllers 28 are connected to the data bus 26 and receive command signals from input device(s) 14 and forward the command signals in an appropriate format for processing. A video controller 30, connected to data bus 26, receives video command signals from the data bus 26 and generates appropriate video signals that are forwarded to the display 16. Output device controllers 32 receive output command signals from data bus 26 and forward appropriate output signals to output device(s) 18.

ROM 22 provides non-volatile data storage for the system 10. In the example shown in FIG. 1, ROM 22 includes a layout generating module 34 that uses elements 36 and layout styles 38 to generate layouts. The layouts are generated for use in a user interface of an application program 40. The layout generating module 34 may be used for generating layouts to more than one application program 40. The layout generating module 34 may comprise a software application written in a language such as SAP's programming language ABAP.

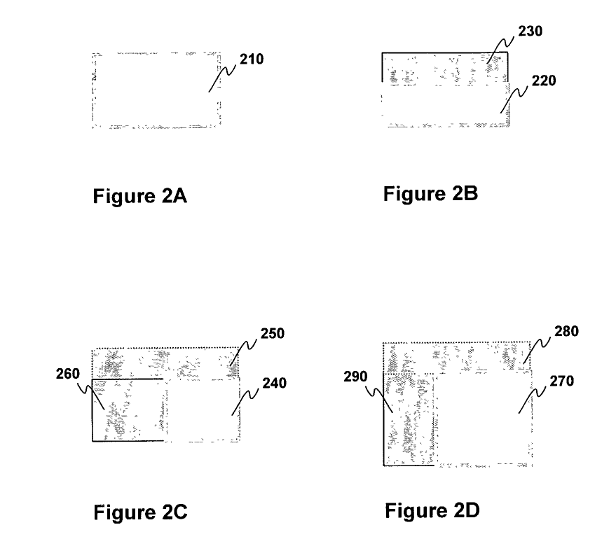

Embodiments of the invention can be used to generate many different layouts. One characteristic of a layout is its shape. The shape of a layout may be determined by one or more factors. Examples of such factors are screen geometry, number and/or sizes of other applications being displayed on the same screen, display resolution, and required character size. FIGS. 2A-2D schematically show exemplary layout shapes 210, 220, 240 and 270. For clarity, the layout shapes are shown without elements and layout styles.

In FIG. 2A, layout shape 210 is shown without any other layout shapes being visible. For example, layout shape 210 may be sized to fill an entire available area on a computer display. However, a layout having the width of layout shape 210 need not be the only layout displayed. FIG. 2B shows a layout shape 220 with a layout shape 230 above it. Layout shape 230 may be associated with the same application as layout shape 220, or with a different program.

FIG. 2C shows a layout shape 240 with two layout shapes 250 and 260. Each of layout shapes 250 and 260 may be associated with the same application as layout shape 220, or with a different program. In this example, the layout shape 240 is narrower and less tall than the available display area. Another such example is the layout shape 270 in FIG. 2D, which is shown with layout shapes 280 and 290.

Creating a layout involves arranging elements in a layout shape. Elements may appear on a computer screen as controls, fields, texts, etc. Buttons, drop-down menus, and checkboxes are examples of control elements. A field may allow a user to enter data in an application, and text may be displayed as a message to the user.

Elements may be provided with predetermined widths. It may be desirable to relate element widths to the width of the layout shape. For example, the width of a layout shape may be divided into a number of columns of equal width. Providing elements with widths that relate to the column width may improve the placement of elements in the layout. For example, layout shapes such as 210 and 220 may suitably be divided into four columns. The width of a column may be referred to as a standard width for elements that are to be placed in such layout shapes. Elements may be given widths corresponding to integer multiples of the standard width. Thus, the width of an element may correspond to one or more standard widths.

An element may include more than one function. For example, more than one control button may be included in an element of standard width. As another example, a one-column element may include a checkbox and explanatory text.

Layout shapes are provided with layout styles to facilitate the placement of elements. Elements are placed in relation to cells in the layout styles. The cells restrict the number of positions on the screen where elements can be positioned.

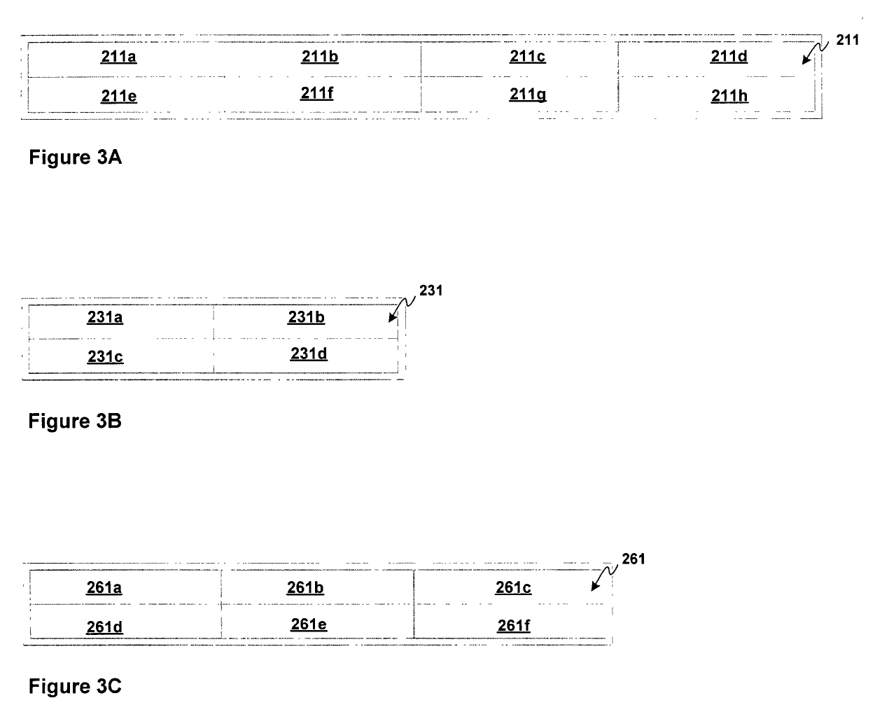

FIGS. 3A-3C show exemplary layout styles 211, 231 and 261. FIG. 3A shows a layout shape provided with layout style 211. Layout style 211 divides the layout shape into four columns, of which cells 211a-h are shown. For example, providing layout shape 210 in FIG. 2A with layout style 211 will allow elements in that layout shape to be placed in four columns. Similarly, layout shape 220 in FIG. 2B can hold elements in four columns if it is provided with layout style 211.

FIG. 3B shows a layout shape provided with layout style 231 which divides the layout shape into two columns, of which cells 231a-d are shown. If, for example, the layout shape 230 in FIG. 2C were provided with layout style 231 it could hold elements in two columns. As another example, FIG. 3C shows layout style 261 dividing a layout shape into three columns. Cells 261a-f are shown. Layout shape 270 in FIG. 2D can hold elements in three columns if it is provided with layout style 261.

It is sometimes desirable to keep groups of elements together during the layout generation and in the resulting layout. This can be done by placing elements that belong together in group boxes. The group boxes can be placed in a suitable layout style. As will be described below, the placement of elements within a group box may be changed during the layout-generating process.

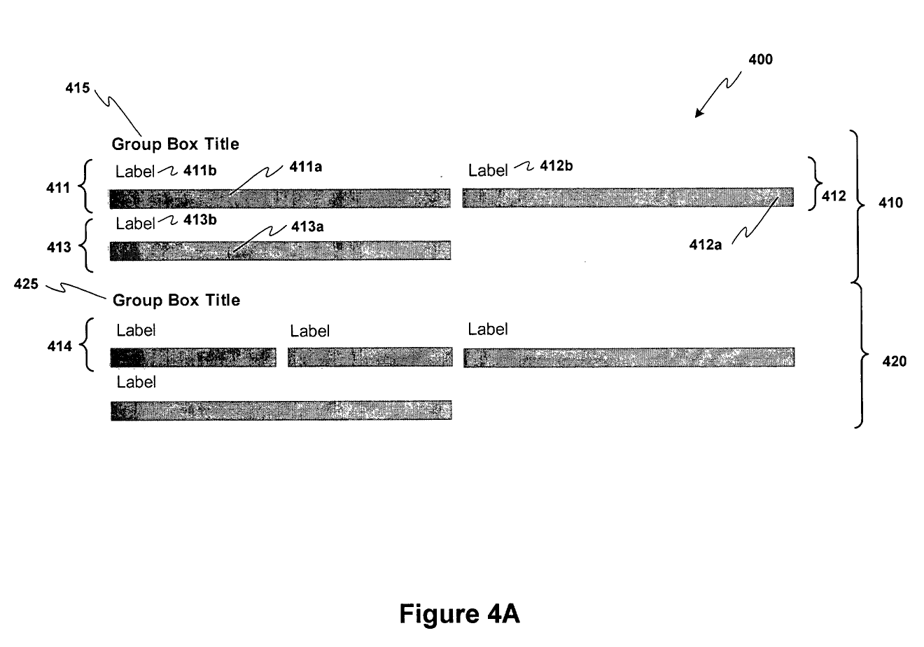

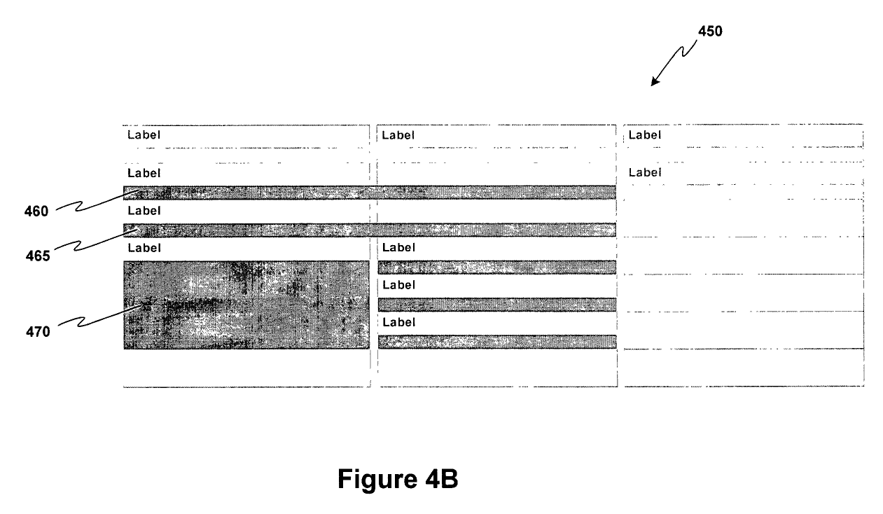

FIG. 4A shows group boxes 410 and 420 in a layout 400. In this example, layout 400 may comprise layout shape 240 provided with layout style 231. Group box 410 includes elements 411, 412 and 413. For example, with reference also to FIG. 1, elements 411-13 may have been allocated to group box 410 by a developer who analyzed which elements should be included in a layout for application program 40. The elements for application program 40, including elements 411-13 in the group box 410, may then be stored as elements 36. Group boxes 410 and 420 have titles 415 and 425, respectively. Each of the group boxes 410 and 420 are surrounded by a thin border to distinguish the contents of the group box from that of adjacent group boxes. Different borders may be used.

Each element in this example includes a field with a label above it. Thus, element 411 includes field 411a and its label 411b, element 412 includes field 412a and its label 412b, and element 413 includes field 413a and label 413b. Fields 411a, 412a, and 413a are schematic representations of any and all functions that can be included in an element, such as a button, a text entry field, or a drop-down menu. Element 414, which has a width corresponding to one column in the layout style, includes two functions.

Elements may be placed row-wise in layout 400. For example, elements 411, 412, and 413 may have been specified to appear in that order. Beginning with element 411, it is placed at the beginning of the first available row in the group box 410. Element 412 fits on the same row and is placed next to element 411. Element 413 does not fit on the same row as element 413 and is placed at the beginning of the next available row.

With reference also to FIGS. 2C and 3B, layout 400 may be created by providing layout shape 240 with layout style 231 and thereafter placing group boxes 410 and 420 in the layout. In this example, each of the group boxes 410 fits on the rows of the layout style 231. The group boxes would also have fit on the rows of the exemplary layout styles 211 and 261, respectively.

Certain sizes of elements may receive special handling in the layout generation.

FIG. 4B shows an arrangement of elements in layout 450. Layout 450 may comprise a layout shape provided with layout style 261, each column of which corresponds to about one third of the width of the layout shape. Elements 460 and 465 each corresponds to two columns of the layout style. It may be desirable to maintain long elements in the same column(s). Elements 460 and 465 have been vertically aligned such that they begin in the same column. For example, if element 465 had originally been placed against the right side of layout 450, it could have been relocated to its position shown in the figure to vertically align it with element 460. In some implementations, long elements are not vertically aligned to each other if they are located in different group boxes.

Tall elements may also be rearranged. Element 470 in FIG. 4B is taller than the other elements in the layout 450. If it had originally been placed in the center column of the layout, it could have been relocated to either a leftmost or a rightmost position on the row. Element 470 is shown in the leftmost position in this figure.

A wide layout style may hold shorter group boxes. As an example, reference is made to FIGS. 3A and 4A. Because layout style 211 has four columns, it could hold the two group boxes 410 and 420 side-by-side in cells 211a-b and 211c-d, respectively. However, there is not any automatic spacing (or “padding”) provided between the cells in the layout styles 211, 213, and 261. This means that the group boxes 410 and 420 may sit too close to each other in the boundary between cells 211b and 211c. The group boxes may be less distinctive if their boundaries blend in with those of other group boxes. The final layout may be less visually appealing if group boxes sit too close to each other (or abut). Moreover, the layout may be more difficult for users to learn and use. A close proximity between elements on a display may suggest a relationship between the elements when none was intended.

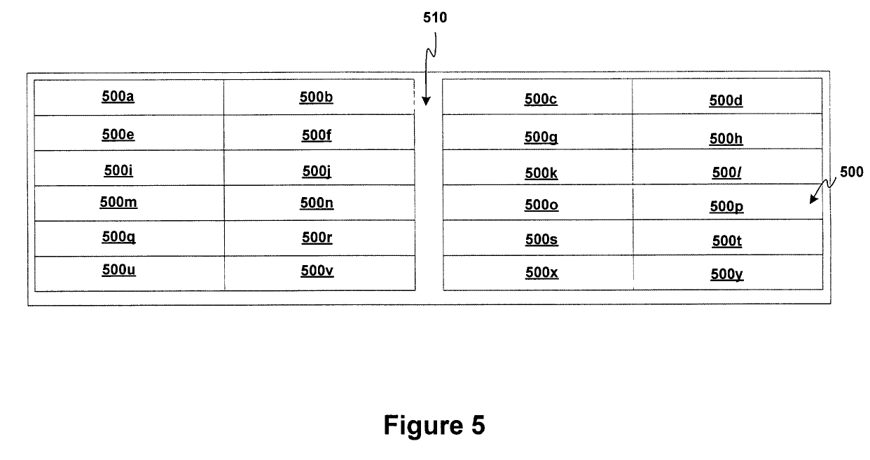

Other layout styles may provide such spacing. FIG. 5 shows a layout style 500 that provides a spacing 510. In this example, the spacing 510 separates the two leftmost columns from the two rightmost columns. The layout style 500 can be provided with elements in any or all of the cells 500a-y.

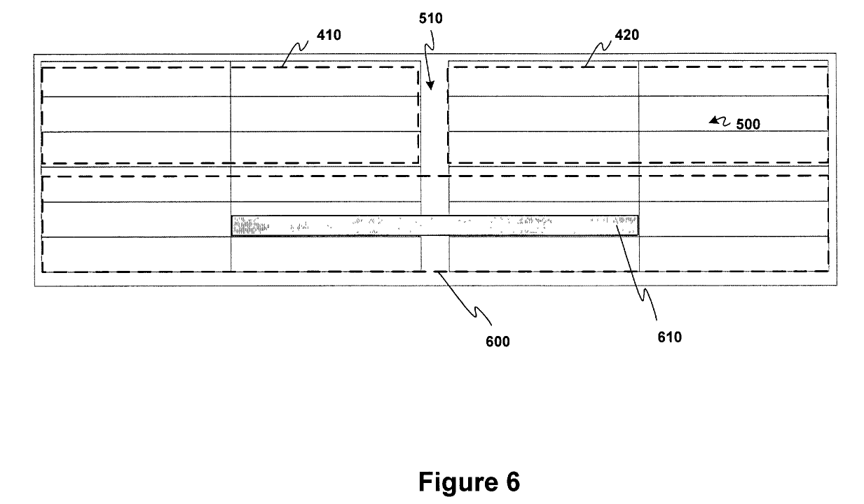

In particular, FIG. 6 shows group boxes 410 and 420 placed side-by-side in the layout style 500. For clarity, the elements inside the group boxes 410 and 420 are not shown in this example. Spacing 510 separates the two group boxes. If all elements that are to be placed in a layout are located in group boxes like the ones in this example, they can be placed in layout style 500 analogous to group boxes 410 and 420.

Importantly, group boxes longer than the above can be used with layout styles that provide spacing. Group box 600 is substantially as wide as the total width of group boxes 410 and 420 side-by-side. The spacing 510 does not restrict the group boxes to a maximum length. In this example, group box 600 spans the entire width of the layout shape and may be used to place elements on both sides of the spacing 510.

Elements can also be displayed across the spacing 510. Group box 600 includes element 610 that spans the two center columns of the layout. Accordingly, using a layout style with spacing may allow group boxes to be placed side-by-side with spacing in between and may also accommodate longer group boxes.

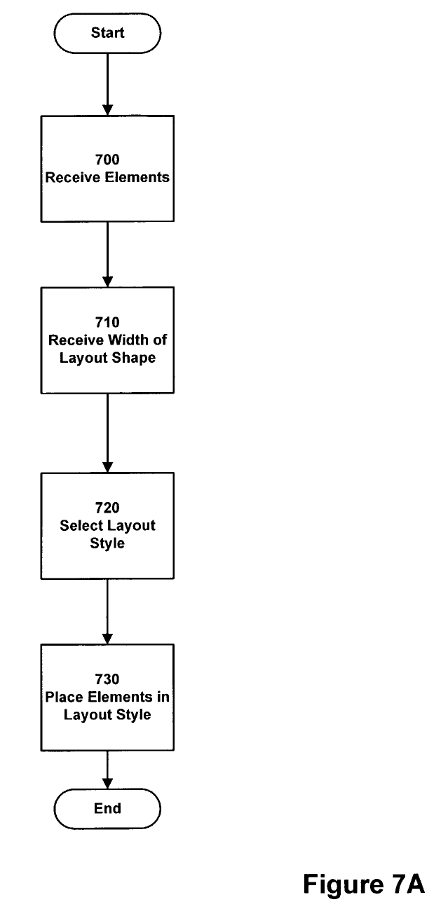

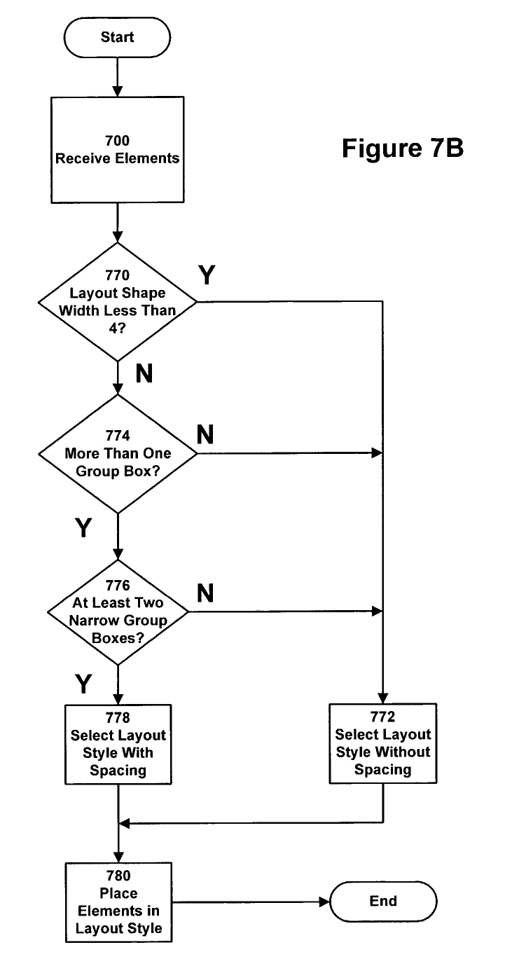

It was mentioned above with regard to FIG. 1 that the system 100 can be used for automatically generating layouts. An example of how the layout generating module 34 can perform automatic layout generation will now be described with reference also to FIGS. 7A and 7B.

FIG. 7A shows a flow chart of steps that may be carried out by the system 100. The layout generating module 34 (LGM) receives elements in step 700 that are to be placed in a layout. In this example, the layout is intended for the application program 40. When the layout has been created, it may be included in the user interface of the application program 40 so that the elements can be shown on display 16.

The LGM may receive elements by accessing elements 36 in ROM 22. The elements 36 may have been identified by a developer during the creation of application program 40. The developer may then have caused the elements to be stored in ROM 22.

In step 710, the LGM receives a width of the layout shape where the elements are to be placed. The layout shape width may have been determined by a user, such as the developer, who may have entered the width into the system 100. The LGM may receive the width by determining which layout shape(s) would fit on the screen, for example by taking into account that other layout shapes 250 and 260 may be present. The width may be expressed in a number of columns, a column representing the present standard width.

The LGM selects a layout style in step 720 using the layout shape width and a standard width. For example, if the layout shape width is given as a number of columns, and the standard width for the elements to be placed in the layout is one column, the LGM can select a layout style capable of holding side-by-side the number of elements corresponding to the layout shape width. The LGM provides the layout shape with the selected style.

In step 730, the LGM arranges the elements in the layout style to create the layout. After placing the elements in the layout style, the layout may be stored in the system 100, or exported outside of the system using output device 18. For example, output device 18 may provide system 100 access to a network. The layout may be considered complete at this point, or it may serve as a proposed layout for further editing.

FIG. 7B shows another flow chart of steps that may be carried out by the system. The LGM receives elements in step 700. In step 770, the LGM determines if the width of the layout shape is less than four standard units. The standard unit may, as has been described, be a measure against which element widths are determined. If the layout shape width is less than four, the LGM selects a layout style in step 772 that does not provide spacing between side-by-side group boxes. Layout styles 211, 231, and 261 are examples of such layout styles.

If the layout shape width is not less than four standard units, the LGM in step 774 determines if more than one group box is present in the received elements. If there is one or no group box, the LGM selects the layout style of step 772.

If there are two or more group boxes in the plurality of elements, the LGM determines in step 776 if there are at least two narrow group boxes. A narrow group box may be one that is no wider than half the layout shape width. For example, if the layout shape is four columns wide, the LGM determines whether there are at least two group boxes that are two columns wide or narrower.

The LGM may determine the group box widths. For example, the LGM can determine the width of all elements in a group box and register the greatest width. This width indicates the minimum width that the group box should have for the elements to fit.

If there is one or no narrow group box, the LGM selects the layout style of step 772. If there are at least two narrow group boxes, the LGM selects in step 778 a layout style that provides spacing between side-by-side group boxes. Layout style 500 is an example of such a layout style.

Having selected a layout style in step 772 or 778, the LGM in step 780 arranges the elements in the layout style to create the layout. If there are group boxes in the layout they will be placed in the selected layout style. If a sequence for the group boxes has been specified, the LGM may arrange the group boxes in the order of the sequence. Alternatively, the LGM may rearrange group boxes, for example as will now be described.

When a layout style without spacing is selected, there may be group boxes if the layout shape is less than four units wide. The layout in FIG. 4A is such an example. The group boxes are placed column-wise in the layout. Each group box may occupy one or more rows in the layout style.

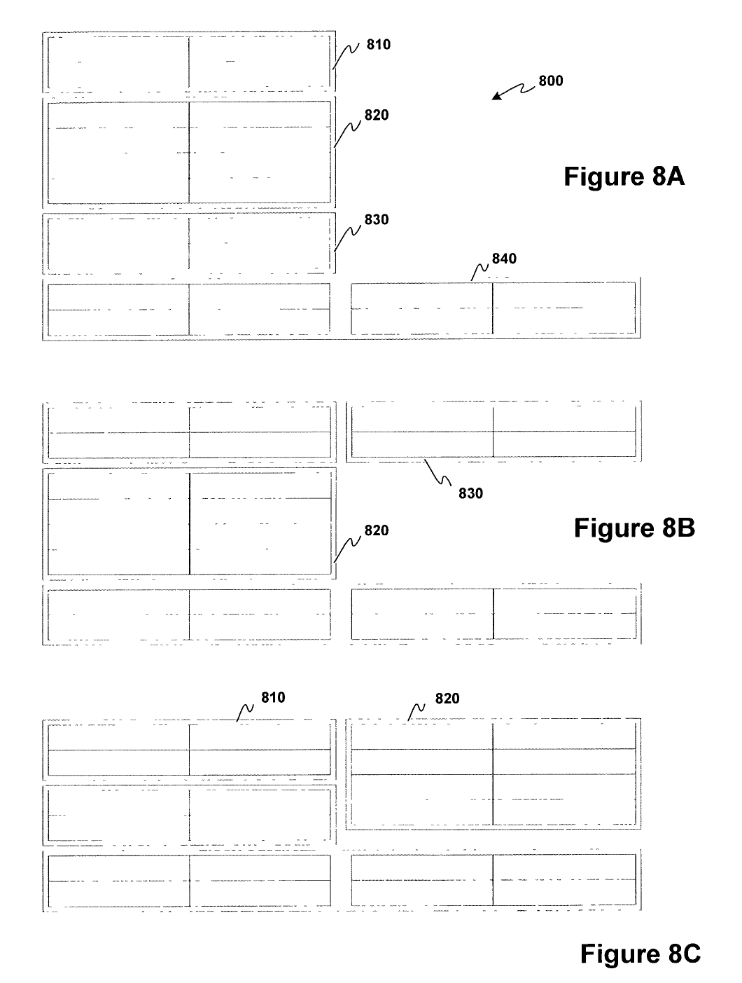

When a layout style with spacing is selected there are at least two narrow group boxes. Examples of placing group boxes in such a layout style will now be given with reference to FIGS. 8A-8C. For clarity, no elements are shown in the group boxes.

FIG. 8A shows group boxes 810, 820, 830, and 840 placed in layout 800. In this example, group box 840 was placed at the end of the layout 800 because it originally followed directly after a narrow group box, such as group box 810. It may be desirable to place long elements at the end of the layout unless they were allocated as the first element in the layout. Accordingly, element 840 was placed at the end of this exemplary layout.

In FIG. 8A, the group boxes have been placed column-wise. The selected layout style provides spacing between side-by-side group boxes, and layout 800 will now be divided in two columns. The LGM may calculate where to make a column break using heights of the group boxes. The LGM may divide a total height of the group boxes by two and break the column at the point closest to this value.

In the example of FIG. 8A, group box 840 has been placed at the end of the layout and may be ignored in the calculation of columns. The three group boxes 810, 820, and 830 are two, four, and two rows high, respectively, for a total of eight rows. Dividing eight by two gives a column break after four of the eight rows. In layout 800, this falls in the middle of group box 820. The LGM may then break the column before or after this group box. In this example, the LGM places the group box between group boxes 820 and 830 as shown in FIG. 8B.

There is a space between group box 830 and group box 840 in FIG. 8B. No group boxes or elements will be placed in this area. Accordingly, it may be considered an inefficient use of real estate. The LGM may detect this situation and rearrange group boxes to improve the layout. For example, the LGM may determine the height of the group boxes in either column. In FIG. 8B, there are eight rows of group boxes on the left side, and four rows on the right side. By reversing the order between group boxes 820 and 830, the height difference can be minimized as shown in FIG. 8C.

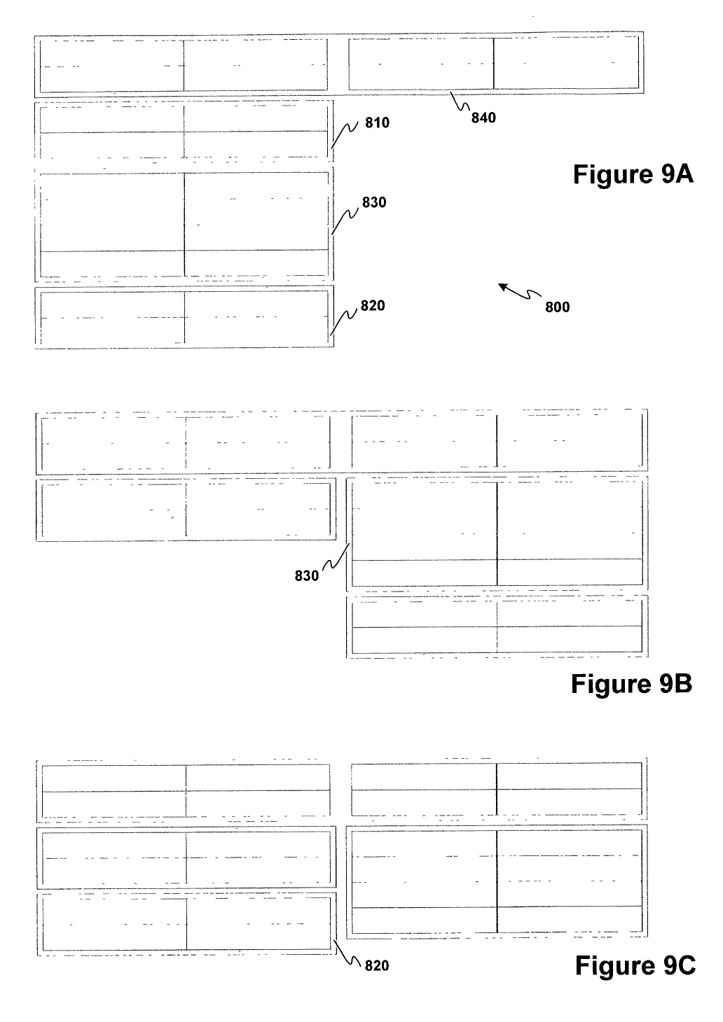

FIG. 9A shows the group boxes 840, 810, 820, and 830 in the layout 800. In this example, group box 840 was the first of the group boxes. Group box 840 may remain at the top of the layout because it was not preceded by a narrow group box. Group boxes 810, 820, and 830 were placed column-wise below group box 840. The LGM may calculate a column break similar to the description of FIG. 8B. In this example, the LGM breaks the column between elements 810 and 830 as shown in FIG. 9B. The LGM may compare the number of rows of group boxes on each side of the layout as described above. In this example, the LGM may decide to minimize the height difference by placing group box 820 before group box 830 as shown in FIG. 9C.

In some embodiments, the layout resulting from the automatic layout generation may be used as a proposal for a final layout. It is possible to modify the layout after it has been generated, using conventional techniques such as manually rearranging elements or group boxes. For example, the proposed layout can be shown on display 16 and may be modified using input devices 14.

Embodiments of the inventive system may offer customers of computer systems an increased ability to customize their user interfaces. Providing such a system with automatic layout generation may make the system more valuable the user. For example, the system may offer the user default layouts for the user interface, with the ability to add or remove elements or group boxes to fit the particular user's needs. The user may cause the selection of elements and group boxes to be stored in ROM 22, and the layout generation module 34 can generate a layout by selecting a layout style in accordance with the above description.

A number of embodiments of the invention have been described. Nevertheless, it will be understood that various modifications may be made without departing from the spirit and scope of the invention. Accordingly, other embodiments are within the scope of the following claims.

I claim:

1. A method of generating a layout for a computer user interface comprising:
receiving a plurality of elements to be placed in a layout, a width of each element being an integer multiple of a standard width;
receiving a width of a layout shape in which the plurality of elements are to be placed;
providing the layout shape with a layout style, the layout style being selected using the layout shape width and the standard width; and
automatically generating the layout by placing the plurality of elements in the layout style.

2. The method of claim 1, wherein placing the plurality of elements comprises placing elements successively on a first row of the layout style as long as they fit, thereafter placing elements on a second row of the layout style below the first row, and so continuing until the plurality of elements has been placed in the layout style.

3. The method of claim 1, further comprising selecting the standard width such that a computer display device can show a predetermined number of columns of the standard width.

4. The method of claim 1, wherein an element comprises more than one function.

5. The method of claim 1, wherein the plurality of elements includes at least two wide elements, each wide element being wider than half the layout shape width, further comprising vertically aligning the at least two wide elements in the layout.

6. The method of claim 5, wherein vertically aligning the at least two wide elements comprises vertically aligning one wide element with a wide element above it in the layout.

7. The method of claim 1, wherein at least one element is taller than the other elements, comprising placing the taller element at an edge of a row in the layout style.

8. The method of claim 1, further comprising determining if at least a group of the received elements are located in a group box and determining a width of such a group box by identifying a widest element within the group box.

9. The method of claim 8, comprising selecting a layout style providing a spacing between side-by-side elements if there are at least two narrow group boxes, each narrow group box being no wider than half the layout shape width.

10. The method of claim 9, wherein a wide group box follows a narrow group box in the plurality of elements, the wide group box being wider than half the layout shape width, further comprising placing the wide group box at an end of the layout.

11. The method of claim 9, wherein the layout style providing a spacing is selected, and wherein the plurality of elements includes a plurality of group boxes, further comprising placing the plurality of group boxes column-wise in the layout style, and dividing the plurality of group boxes into two columns.

12. The method of claim 11, further comprising rearranging elements to reduce a height difference between the two columns.

13. The method of claim 9, further comprising placing a group box across the spacing.

14. The method of claim 13, wherein an element of said group box is placed across the spacing.

15. The method of claim 8, comprising selecting a layout style not providing a spacing between side-by-side elements if there is less than two narrow group boxes, each narrow group box being no wider than half the layout shape width.

16. The method of claim 15, wherein the layout style not providing a spacing between side-by-side elements is selected, further comprising placing group boxes column-wise in the layout style.

17. A system for automatic layout generation comprising:
a plurality of elements to be placed in a layout shape, a width of each element being an integer multiple of a standard width;
layout styles in which elements can be placed; and
a layout generating module selecting a layout style for the plurality of elements using a width of the layout shape and the standard width, the module generating a layout by placing the elements in the selected layout style.

18. The system of claim 17, wherein the layout generating module determines if at least a group of the received elements are located in a group box and determines a width of such a group box by identifying a widest element within the group box.

19. The system of claim 18, wherein the layout generating module selects a layout style providing a spacing between side-by-side group boxes if there are at least two group boxes being no wider than half the layout shape width.

20. The system of claim 18, wherein the plurality of elements includes a narrow group box in sequence before a wide group box, the wide group box being wider than half the layout shape width and the narrow group box being no wider than half the layout shape width, comprising placing the wide box at an end of the layout.

21. Computer readable medium having stored thereon instructions for causing a digital data processing system to perform operations comprising:
receive a plurality of elements to be placed in a layout, a width of each element being an integer multiple of a standard width;
receive a width of a layout shape in which the plurality of elements are to be placed;
provide the layout shape with a layout style, the layout style being selected using the layout shape width and the standard width; and
automatically generate the layout by placing the plurality of elements in the layout style.

22. The medium of claim 21, further comprising determining if at least a group of the received elements are located in a group box and determining a width of such a group box by identifying a widest element within the group box.

23. The medium of claim 22, comprising selecting a layout style providing a spacing between side-by-side group boxes if there are at least two group boxes being no wider than half the layout shape width.

24. The method of claim 22, wherein the plurality of elements includes a narrow group box in sequence before a wide group box, the wide group box being wider than half the layout shape width and the narrow group box being no wider than half the layout shape width, comprising placing the wide box at an end of the layout.
